(19) United States
(12) Patent Application Publication
(10) Pub. No.: US 2009/0086237 A1
(43) Pub. Date: Apr. 2, 2009

(54) Systems and Methods for Document Printing

(76) Inventor: Junichiro Hamaguchi, Pleasanton, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/864,757

(22) Filed: Sep. 28, 2007

(51) Int. Cl. G06F 3/12; G06F 15/00

(52) U.S. Cl. 358/1.13

(57) ABSTRACT

Systems and methods consistent with described embodiments provide a method to specify printer configurations for individual document pages and to print the document in accordance with the printer configuration specified for each individual document page. In some methods for printing documents, at least one filter includes printer configuration information that may be applied to a document on a page-by-page basis to filter at least one of a plurality of document pages in a document. In some embodiments, the filter is applied to a PDL description of the document on a page-by-page basis to generate a page-by-page filtered PDL description of the document and the filtered PDL description is sent to a printer for printing.

### FIELD OF THE INVENTION

The present invention relates to the field of document printing and, in particular, to systems and methods for configuring printers.

### DESCRIPTION OF RELATED ART

Documents are typically created using word processing software that may allow users to enter and edit data, specify fonts used, and format data contained in the document. Data within the document may include text, figures, images, tables, mathematical equations, or other types of application specific data. Modern document processing software is generally of the “What You See Is What You Get” (“WYSIWIG”) type, in which the document being edited by a user appears on a display device as it would appear in print. WSYIWIG document processing software allows users to have an accurate visual on-screen depiction of a document, as the document would appear in print.

However, users may not always desire to print documents as they appear on screen. For example, a user may want to print a document containing colored images in black and white or monochrome in order to decrease printing cost, conserve color ink, or to increase printing speed. To allow users the option to a print document in a format different from that specified in the document itself, document processing software may interact with other software, such as a printer driver, to allow printing device or printer (hereinafter printer) configurations to be changed. For example, a printer may be configured by a user to print all documents in black and white or monochrome. Other users who wish to print documents in color on that printer may override the prior setting by changing the printer's configuration. Typically, printer configuration options are provided to users by document processing software through a “printer properties” or “printer setup” menu option.

Document processing software therefore allows users some limited capacity to configure printers or printers. For example, a user may be allowed to choose a paper size or a print tray on a printer, a printer resolution specified as dots per inch (“dpi”), and/or color options for a printer. However, such printer options operate on an entire document. For example, choosing black and white or monochrome printing will cause the entire document to be printed in black and white. Users cannot specify that some pages in document print in black and white while other pages print in color without a cumbersome process. Thus, current methods do not give users the capability to flexibly specify printer configurations corresponding to individual pages of a document. The inability to specify printer configuration options for individual document pages also presents a problem when multiple users are working on a single document but desire different printer configurations.

The ability to change the configuration of a printer according to a page based print configuration desired for a document would offer several advantages including increasing user flexibility, promoting document sharing, and simplifying the printing of documents according to user specified preferences for various individual document pages.

### SUMMARY

In embodiments consistent with the present invention, systems and methods to specify a printer configuration on a page-by-page basis for documents and to print the document pages in accordance with the printer configuration specified individually for the document pages are presented.

In some methods for printing documents, at least one filter includes printer configuration information corresponding to at least one of a plurality of document pages in a document. The filter may be applied to a PDL description of the document on a page-by-page basis to generate a page-by-page filtered PDL description of the document and the filtered PDL description is sent to a printer for printing. In one embodiment, applying the filter to a PDL description of the document on a page-by-page basis to generate a page-by-page filtered PDL description of the document may further comprise altering color-related PDL descriptions of at least one page subsequent to a first page of the document to enable the at least one page to be printed in monochrome.

In some implementations, the methods may be executed by one or more of a print server coupled to the printer, and/or a processor coupled to the printer. The document may be described in a page description language such as PostScript, and in some embodiments, the filter to be applied to a document may be selected from one or more filters associated with a document. A document page may comprise of one or more pages in the document.

These and other embodiments are further explained below with respect to the following figures.

### BRIEF DESCRIPTION OF THE DRAWINGS

The accompanying drawings illustrate a number of non-limiting embodiments of the invention and, together with the description, serve to explain the principles of the invention. In the figures, elements with similar functions are prefixed with the same numeric identifier, and individual instances are identified with a hyphenated ordinal suffix.

FIG. 1 shows a block diagram of a system for the configuration of printers according to some embodiments of the invention.

FIG. 2 shows a block diagram of an exemplary system, including a software hierarchy for the configuration of printers according to some embodiments of the invention.

FIG. 3 shows a flowchart depicting an exemplary method for the creation and modification of filter file according to some embodiments of the present invention.

FIG. 4 shows a flowchart depicting an exemplary method to apply print configurations to individual pages of a file according to some embodiments of the present invention.

FIG. 5 shows an exemplary process illustrating the application of a filter to print commands in a file according to some embodiments of the present invention.

### DETAILED DESCRIPTION

Consistent with embodiments described herein, systems and methods to specify print attributes for individual document pages and to print documents in accordance with print attributes specified for individual document pages are presented.

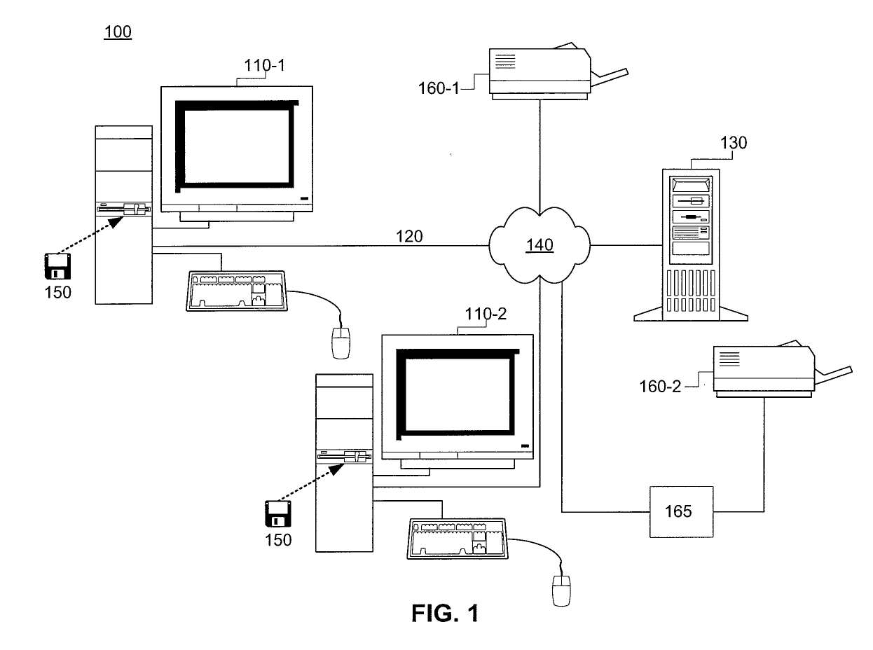

FIG. 1 shows a block diagram 100 of an exemplary system for the configuration of printers. A computer software application consistent with the present invention may be deployed on a network of computers, as shown in FIG. 1, that are coupled through communication links that allow information to be exchanged using conventional communication protocols and/or data port interfaces.

As shown in FIG. 1, exemplary system 100 includes computing devices 110-1 and 110-2 and server 130. Further, computing devices 110-1, 110-2, and server 130 may communicate over a connection 120, which may pass through network 140, which in one case can be the Internet. Computing device 110 may be a computer workstation, desktop computer, laptop computer, or any other computing device capable of being used in a networked environment. Server 130 may be a platform capable of connecting to computing device 110 and to other devices (not shown). Computing device 110 and server 130 may be capable of executing software (not shown) that allows the control and configuration of printer 160. In some embodiments, printer 160 may be a printer that is capable of being dynamically configured and/or reconfigured.

Exemplary computing device 110 also contains removable media drive 150. Removable media drive 150 may include, for example, 3.5 inch floppy drives, CD-ROM drives, DVD ROM drives, CD±RW or DVD±RW drives, flash memory, USB flash drives, memory cards, and/or any other removable media drives. In some embodiments, portions of the software application may reside on removable media and be read and executed by computing device 110 using removable media drive 150.

Connection 120 couples computing devices 110-1, 110-2, printers 160-1, 160-2, and server 130, and may be implemented as a wired or wireless connection using conventional communication protocols and/or data port interfaces. In general, connection 120 can be any communication channel that allows transmission of data between the devices. In some embodiments, the devices may be provided with conventional data ports such as Ethernet, USB, SCSI, Bluetooth, IrDA, and/or Firewire ports for transmission of data through the appropriate connection 120. Exemplary connection 120 may be a Digital Subscriber Line (DSL), an Asymmetric Digital Subscriber Line (ADSL), or a cable connection. The communication links could be wireless links or wired links or any combination that allows communication between computing devices 110, server 130, and printer 160. Network 140 could include a Local Area Network (LAN), a Wide Area Network (WAN), or the Internet. Information sent over network 140 may be encrypted in some instances to ensure the security of the data being transmitted.

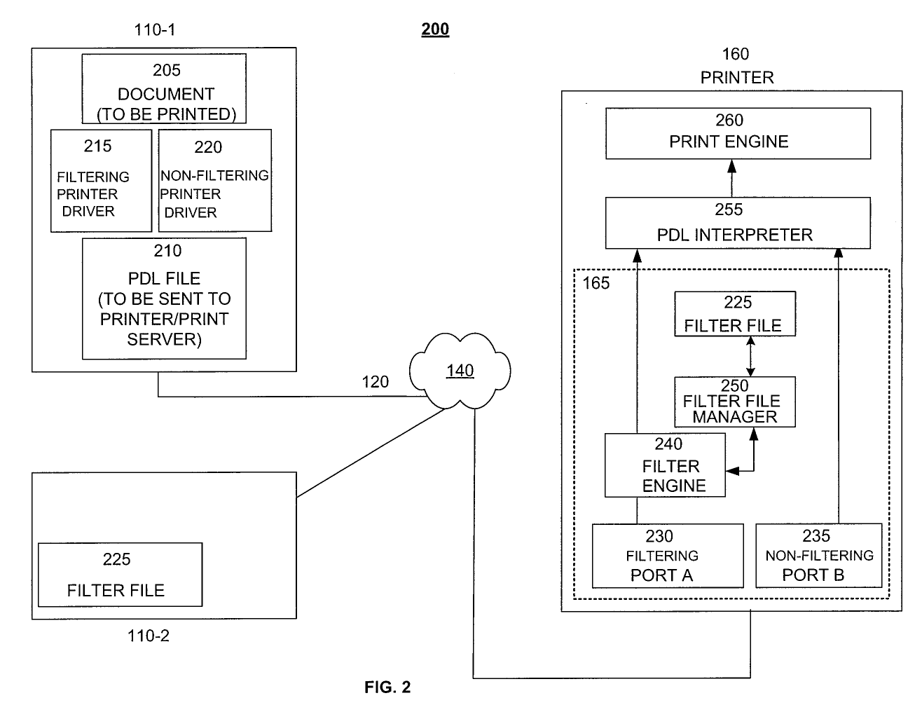

Printer 160-1 is coupled to network 140 through connection 120. As shown in FIG. 2, printer 160-2 may also be coupled to network 140 using print server 165. Exemplary print server 165 may spool, queue, store, and process print jobs for execution on printer 160-2. In one embodiment, print server 165 may be implemented as a software program that provides print related services to users and applications requesting printing. For example, print server software may run on computing device 110 or server 130. In another embodiment, print server may be a hardware device that is coupled to printer 160-2 and may include processors, memory, and network communication capabilities. In some embodiments, print server 165 may provide communication ports, including multiple ports for receiving data.

Exemplary printer 160 may be connected directly to computing device 110 and/or server 130. System 100 may include other printers 160 (not shown) according to some embodiments of the invention. In other embodiments, printer 160 may be a network printer and provide communication ports, including multiple ports for receiving data. Exemplary printer 160 may be controlled by software running on a processor coupled to printer 160, which may be an embedded processor, or an application specific integrated circuit (“ASIC”). In some embodiments, printer 160 may also have memory, including non-volatile random access memory (“NVRAM”), or flash memory to store data and/or control information that may be accessed by a processor coupled to printer 160. Printer 160 may also be controlled in part by software, including device driver software, running on computing devices 110-1, 110-2, print server 165, or server 130.

In some embodiments, configuration parameters pertaining to printer 160 may be user-configurable. For example, the print resolution, paper sizes, output trays, color options, and other device parameters of printer 160 may be user-configurable. In general, the nature and type of configuration options will depend on the features available on a specific printer. Further, information transferred to and/or from printer 160 may be stored on one or more of computing devices 110-1, 110-2, print server 165, and/or server 130 for additional processing.

A computer software application consistent with embodiments of the invention may be deployed on any of the exemplary computers, as shown in FIG. 1. For example, computing devices 110-1, 110-2, server 130, print server 165, or a processor coupled to printer 160 may execute software resident on storage media or memory coupled to the respective devices. In some embodiments, the software application may be distributed across computing devices 110-1, 110-2, server 130, print server 165, and/or printer 160 so that portions of the software application may be executed by one or more of the components.

FIG. 2 shows a block diagram of an exemplary system 200, including a software hierarchy for the configuration of printers. In some embodiments, a user wishing to apply a print configuration to individual pages of document 205 may select a printing option that invokes filtering printer driver 215 running on computing device 110-1. For example, document processing software may offer a user two printing options corresponding to the same printing device. One printing option may invoke filtering printer driver 215, while the other would invoke non-filtering printer driver 220. In some embodiments, filtering printer driver 215 may operate on document 205 on a page-by-page basis. The drivers may process document 205 to generate a Page Description Language (“PDL”) file 210.

The page description language allows the description of a printed page in a printer independent format. PDL's may include languages such as PostScript, Printer Command Language (“PCL”), Portable Document Format (PDF), Device Independent (“DVI”), Graphics Device Interface (“GDI”), Personal Printer Data Stream (“PPDS”), XML Paper Specification (XPS) etc., and other well-known and/or proprietary page description languages. Accordingly, a PDL description may describe a document 205 in terms of its page layout. Printer 160 may then process the information in PDL file 210 using PDL interpreter 255 to generate printer specific instructions, which when executed can generate the printed document. Exemplary PDL file 210, which may contain PDL descriptions for multiple pages, provides an interface between print drivers 215 or 220, and a print server 165 or printer 160. PDL file 210 may contain document formatting instructions in a page description language supported by a particular printer. For example, margin formatting, font management, and finishing options such as two sided printing and stapling may be controlled by information contained in PDL file 210. In some embodiments, PDL file 210 may include a list of commands, and data to which the commands apply.

In some embodiments, filtering printer driver 215 may operate on the document to be printed 205 and send the resulting PDL file 210 to printer 160 over network 140. Filtering allows the manipulation of a print job in accordance with user preferences before the job is executed by printer 160. In some embodiments, exemplary filtering printer driver 215 may perform some steps in a sequence of steps to print individual pages of file 205 according to their respective print configurations. In some embodiments, filtering printer driver 215 may operate on document 205 on a page-by-page basis.

Exemplary PDL file 210 may be sent to print server 165 (indicated by the dotted lines in FIG. 2) for processing and forwarding to printer 160 coupled to the print server such as exemplary printer 160-2. Functionality provided by print server 165, using hardware, software, firmware, or some combination of thereof, may be incorporated within printer 160 or may be provided separately. In one embodiment, printer 160 may include print engine 260 and PDL interpreter 255, whereas print server 165 may include filter file 225, filter file manager 250, filter engine 240, and ports such as exemplary Port-A 230, and Port-B 235. In another embodiment, printer 160 may include print engine 260, PDL interpreter 255, filter file 225, filter file manager 250, filter engine 240, and ports such as exemplary Port-A 230, and Port-B 235. The distribution of the exemplary elements listed above may be changed according to user or system needs. It should be noted that system 200 shown in FIG. 2 is exemplary and for illustrative purposes only.

Exemplary filter file 225 may contain some parts of the configuration to be applied to individual pages of PDL file 210 Exemplary filter file 225 may be created, edited, or otherwise modified on computing device 110-2, or on server 130, computing device 110-1 and may be uploaded to an appropriate location on printer 160 or print server 165. In some embodiments, functionality to manage uploads, delete, and/or to select a filter file for use on printer 160 may be provided through filter file manager 250.

Communication between computing devices 110-1, 110-2, print server 165, and/or printer 160 may occur using various protocols, such as the TCP/IP protocol. In some embodiments, certain types of communications may be directed to specific communication ports on printer 160 or print server 165. For example, port A 230 may be configured as a “filtering port” so that all files 210 directed to port A 230 may be forwarded to filter engine 240. Similarly, port B 235 may be configured as a “pass-through” port so that a print job sent to port B 235 will not undergo any filtering. For the purposes of this description, port A 230 may be viewed as a filtering port, while port B 235 may be seen as a pass-through or non-filtering port. Note that other configurations of ports are possible and the embodiments discussed are exemplary and for descriptive purposes only. Exemplary filter engine 240 may obtain the selected filter file 225 through filter manager 250 and use the information contained in filter file 225 to perform actions on files 210 received for printing on port A 230.

Accordingly, PDL Interpreter 255 can receive a filtered PDL file from filter engine 240, or unfiltered PDL file 210 from port B 240. In some embodiments, PDL interpreter 255 defines how elements such as text and graphics may appear on a printed page. In some embodiments, the output generated when PDL interpreter 255 acts on its input files is sent to print engine 260, which controls printer hardware on printer 160 to generate appropriately formatted printed documents.

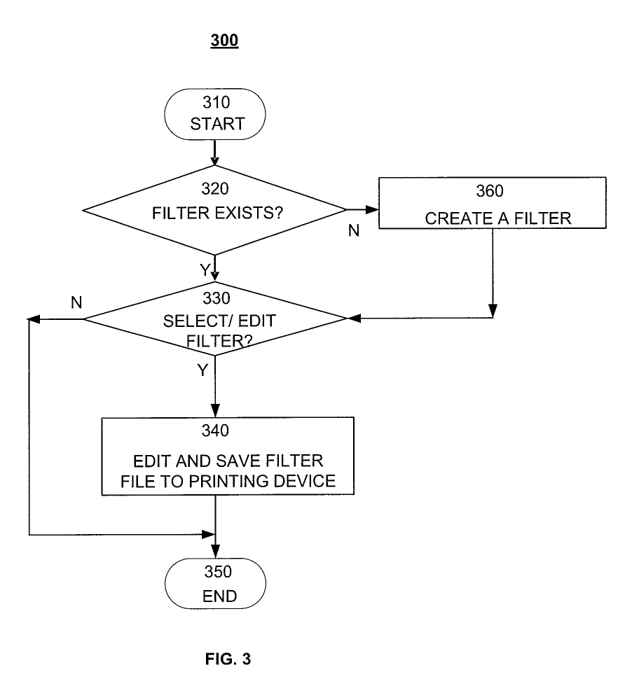

FIG. 3 shows a flowchart 300 depicting an exemplary method for the creation and modification of filter file 225 according to some embodiments of the present invention. The algorithm may commence in step 310 may check for existing filter files 225 in step 320. If no filter files 225 exist, then a new filter file 225 may be created according to user instructions in step 360. Filter file 225 may include instructions for processing unfiltered PDL file 210 on a page by page basis. In some embodiments, filter file 225 may be implemented using a scripting or programming language. Filter file 225 may contain instructions to extract information from unfiltered PDL file 210 including page related information that may be present in a header and operate on the information. If one or more filter files 225 exist, then the user may select an appropriate filter file 225, edit filter file 225, and save edited filter file 225 to printer 160, or print server 165 in step 340. If the user chooses not to edit an existing filter file 225 in step 330, or if an edited filter file 225 has been saved successfully in step 340, then the algorithm terminates in step 350.

The steps outlined in flowchart 300 may be executed by a program running on one or more of computing devices 110-1, 110-2, printer 160, print server 165, and/or server 130. In some embodiments, users may set up individual filter files 225 and select an appropriate filter file 225 using filter manager 250. In some embodiments, a system administrator may set up a default filter file 225 for use with a particular printer 160. In other embodiments, users may be associated with individual profiles that specify the filter to be used for individual users or individual user-printer combinations. For example, a user may set up a default profile that invokes a specified filter whenever a job with the user's id is sent to printer 160. In another example, a user may set up and associate different default filters for different printers so that the appropriate printer-specific filter can be applied when a print job associated with the user's id is sent to a given printer. Users may be identified by their login-id, network-id, group-id, or any other scheme used in a given setting.

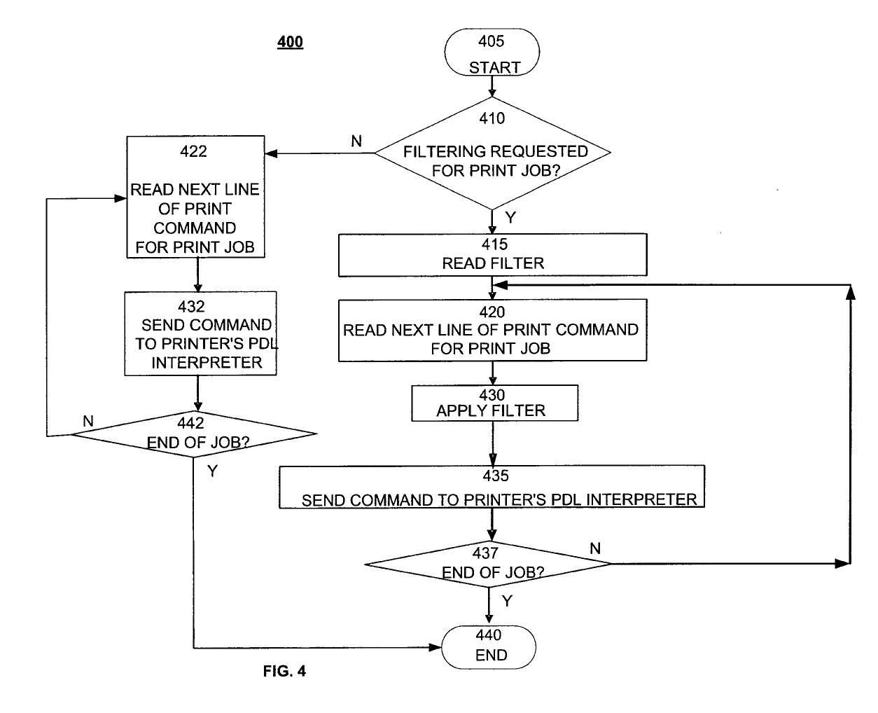

FIG. 4 shows a flowchart 400 depicting an exemplary method to apply print configurations to individual pages of a file according to some embodiments of the present invention. Some or all of the steps depicted in flowchart 400 may be performed by one or more of a combination of computing devices 110, server 130, print server 165, or printer 160.

The algorithm may commence in step 405. Next, in step 410, the algorithm determines whether filtering has been requested for the print job, which may take the form of PDL file 210. In some embodiments, the port at which the job was received may be used to make a determination of whether a job needs filtering. For example, jobs received on port A 230 may be filtered.

Exemplary filter file 225 may be read in step 415 to determine print configurations to be applied to a job for which filtering has been requested. In some embodiments, filter file 225 may be read by filter engine 240 running on printer 160 or print server 165. In step 420, the next line or page in a list of print commands associated with PDL file 210 to be printed may be read. Next, in step 430, the filter specified in filter file 225 may be applied to the line read in step 420. In some embodiments, a filter file A print command may be altered based on filter settings, if specified by conditions set in the filter. For example, a filter may replace all occurrences of “color” appropriately specified in a page description language, with “black and white” for all pages in PDL file 210 after the first page. Accordingly, page 1 in PDL file 210 will not be changed by the filter, but subsequent pages will have occurrences of “color” replaced with “black and white.” Thus, the first page of document 205 may print in color while all subsequent pages will print in black and white.

In step 435, the filtered print command may be sent to the PDL interpreter 255 on printer 160. In step 437, the print job may be checked to determine if additional print commands remain to be processed. If the print job has not ended then, the algorithm returns to step 420. If the print job has ended, then the algorithm may proceed to step 440, where it terminates.

If filtering has not been requested for a print job then the algorithm may iterate through steps 422, 432, and 442 until the print job has ended. In step 422, the next line in a list of print commands associated with unfiltered PDL file 210 to be printed is read. Next, in step 432 the command is sent to PDL interpreter 255 on printer 160. In step 442, the print job is checked for termination. If the print job has not ended then, the algorithm may return to step 422 otherwise it can proceed to step 440, where it terminates.

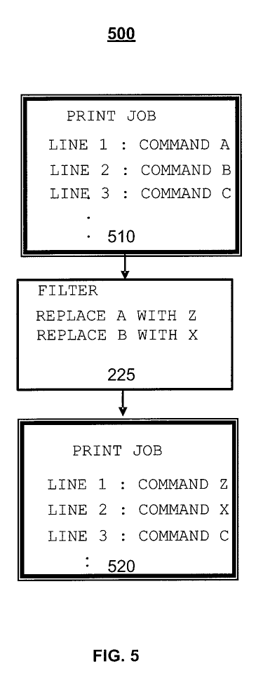

FIG. 5 shows an exemplary process illustrating the application of a filter to print commands in a file. It should be noted that the process depicted in FIG. 5 is exemplary and for illustrative purposes only. Other methods or processes may be used to apply filters to print commands in a manner consistent with disclosed embodiments.

As shown in FIG. 5, a print job may consist of a list of commands 510. For example, the list of commands 510 may be PostScript style commands. The commands may also be specified in other PDL languages. As shown in FIG. 5, the exemplary command list 510 in PDL file 210 may be given by the commands COLOR, B, C, and D, respectively. The commands shown in FIG. 5 are exemplary and for descriptive purposes only. For illustration, the commands are shown with a page and line number. In an actual PDL file, for example, the page number and other information may be obtained easily by parsing page header or job information. Further, other commands and/or data may follow the commands shown. Exemplary filter file 225 may contain commands that specify how exemplary commands COLOR, B, C, and D are to be filtered. Filters specified in exemplary filter file 225 direct the replacement of command COLOR with BW whenever the page number exceeds one. An exemplary final command list 520 in the filtered PDL file shows a new command list given by commands, COLOR, BW, B, C, and D, respectively, following the application of the filter. If the exemplary print job described by filtered command list 520 is processed, then the first page will print in color and all subsequent pages will print in black and white.

Further, methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention. Moreover, there are many computers and operating systems that may be used in practicing embodiments of the instant invention and, therefore, no detailed computer program could be provided that would be applicable to these many different systems. Each user of a particular computer will be aware of the language, hardware, and tools that are most useful for that user's needs and purposes.

The above-noted features and aspects may be implemented in various environments. Such environments and related applications may be specially constructed for performing the various processes and operations, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs, or it may be more convenient to construct a specialized apparatus or system to perform the required methods and techniques. Embodiments of the present invention also relate to computer-readable media that include program instructions or program code for performing various computer-implemented operations based on described methods and processes. The program instructions may be those specially designed and constructed for the purposes of the invention, or they may be of the kind well known and available to those having skill in the computer arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A method for printing documents according to printer configuration information contained in a filter, wherein the printer configuration information corresponds to at least one of a plurality of document pages in the document , the method comprising:
applying the filter to a PDL description of the document on a page-by-page basis to generate a page-by-page filtered PDL description of the document; and
sending the filtered PDL description to a printer for printing.

2. The method of claim 1, wherein applying the filter to a PDL description of the document on a page-by-page basis to generate a page-by-page filtered PDL description of the document further comprises altering color-related PDL descriptions of at least one page subsequent to a first page of the document to enable the at least one page to be printed in monochrome.

3. The method of claim 1, wherein the method is executed on a print server.

4. The method of claim 1, wherein the method is executed by a processor that is coupled to the printer.

5. The method of claim 1, wherein the PDL is PostScript.

6. The method of claim 1, wherein the filter is selected from at least one filter associated with a document.

7. A system comprising:
at least one processor capable of processing PDL data;
a memory coupled to the processor wherein information stored in the memory comprises:
instructions for the processor;
a PDL description of a document; and
a filter, wherein the filter comprises printer configuration information corresponding to at least one of a plurality of document pages in the document; and
a printer coupled to the processor and memory;
wherein the processor executes instructions stored in the memory to perform steps in a method comprising:
applying the filter to the PDL description of the document on a page-by-page basis to generate a filtered page-by-page PDL description of the document; and
sending the filtered PDL description to the printer for printing.

8. The system of claim 7, wherein applying the filter to a PDL description of the document on a page-by-page basis to generate a page-by-page filtered PDL description of the document further comprises altering color-related PDL descriptions of at least one page subsequent to first page in the document to enable the at least one page to be printed in monochrome.

9. The system of claim 7, wherein the method is executed on a print server.

10. The system of claim 7, wherein the PDL is PostScript.

11. The system of claim 7, wherein the filter may be selected from at least one filter associated with a document.

12. A computer-readable medium that stores instructions, which when executed by a processor perform steps in a method comprising:
applying the filter to a PDL description of the document on a page-by-page basis to generate a page-by-page filtered PDL description of the document; and
sending the filtered PDL description to a printer for printing.

13. The computer- readable medium of claim 7, wherein the step of applying the filter to a PDL description of the document on a page-by-page basis to generate a page-by-page filtered PDL description of the document further comprises altering color-related PDL descriptions of at least one page subsequent to a first page in the document to enable the at least one subsequent page to be printed in monochrome.

14. The method of claim 12, wherein the method is executed on a print server.

15. The method of claim 12, wherein the method is executed by at least one processor coupled to the printer.

16. The method of claim 12, wherein the PDL is PostScript.

17. The method of claim 12, wherein the filter may be selected from at least one filter associated with a document.

18. A computer readable memory containing instructions for controlling at least one processor to perform steps in a method of printing documents comprising:
applying the filter to a PDL description of the document on a page-by-page basis to generate a page-by-page filtered PDL description of the document; and
sending the filtered PDL description to a printer for printing.

19. The computer- readable memory of claim 18, wherein the step of applying the filter to a PDL description of the document on a page-by-page basis to generate a page-by-page filtered PDL description of the document further comprises altering color-related PDL descriptions of at least one page subsequent to a first page in the document to enable the at least one page to be printed in monochrome.

20. The method of claim 18, wherein the PDL is PostScript.
